(19) United States
(12) Patent Application Publication
(10) Pub. No.: US 2013/0066944 A1
(43) Pub. Date: Mar. 14, 2013

(54) SOCIAL GATHERING OF DISTRIBUTED KNOWLEDGE

(71) Applicants: Jim A. Laredo, Katonah, NY (US); Sriram K. Rajagopal, Chennai (IN); Maja Vukovic, New York, NY (US)

(72) Inventors: Jim A. Laredo, Katonah, NY (US); Sriram K. Rajagopal, Chennai (IN); Maja Vukovic, New York, NY (US)

(73) Assignee: INTERNATIONAL BUSINESS MACHINES CORPORATION, Armonk, NY (US)

(21) Appl. No.: 13/231,604

(22) Filed: Sep. 13, 2011

(51) Int. Cl. G06F 15/16

(52) U.S. Cl. 709/203

(57) ABSTRACT

Management of a task made up of a list of activities is presented. A task includes an identification of a task creator and of a set of task activities retrieved by a computer system. A user likely to perform a portion of the set of activities is identified, wherein the portion includes one or more activities of the set of activities, and at least a portion of the set of activities is selectively delegated. The delegated portion of the set of activities is sent to the identified user. A set of responses related to the portion of the set of activities is received. Whether the task is complete is determined based on a policy for establishing that the set of responses meets a configured confidence level. Such set is reported to a task creator as responsive to determining completion of the set of responses.

### BACKGROUND

1. Field

The disclosure relates generally to processing and managing a task and more specifically to conducting a de-constructed search for knowledge across multiple parties.

2. Description of the Related Art

It is often possible to discover and gather structured knowledge around an asset through the systems that execute such an asset. For example, we can discover an asset's configuration or other attributes as long as they have been predefined and the computer can locate the knowledge. However, the same cannot be said about discovering unstructured knowledge, or distributed knowledge, that resides outside an asset, contained in a variety of documents or other knowledge storage medium, located in a number of locations and rarely centralized or in the collective possession of specialists. Such distributed knowledge can, for example, relate to execution or use of the asset, especially how people may use it, ad-hoc know how, best practices, or runtime requirements as they relate to compliance or deployment, as just a few examples. This distributed knowledge can be considered hard to discover knowledge, because it rarely can be easily discovered since it can reside in many locations, both known and unknown by one seeking the distributed knowledge.

A family of assets may contain thousands or tens of thousands of assets, as in, for example, the case of server or applications within the realm of information technology optimization. Gathering distributed knowledge for a whole family of assets becomes challenging, as gathering this knowledge can be difficult and time consuming. Accordingly, it would be advantageous to have a method and apparatus, which takes into account one or more of the issues discussed above as well as possibly other issues. The approach described herein uses social networking techniques that help to discover individual knowledgeable persons related to the asset or that can otherwise contribute sought distributed knowledge.

### SUMMARY

Embodiments of the invention manage tasks, wherein each task can comprise a unit of work associated with gathering a portion of distributed knowledge. According to one illustrative embodiment of the present invention, a task includes an identification of a task creator and an identification of a set of activities of the task retrieved by a computer system. A user likely to perform a portion of the set of activities is identified, wherein the portion includes one or more activities of the set of activities, and at least a portion of the set of activities is selectively delegated. The delegated portion of the set of activities is sent to the identified user. A set of responses related to the portion of the set of activities is received. Whether the task is complete is determined based on a policy for establishing that the set of responses meets a configured confidence level. The set of responses is reported to the task creator as responsive to determining completion of the set of responses.

### BRIEF DESCRIPTION OF THE SEVERAL VIEWS OF THE DRAWINGS

FIG. 1 is an illustration of a block diagram of a data processing system in accordance with an illustrative embodiment.

FIG. 2 is an illustrative diagram of a data processing environment in accordance with an illustrative embodiment.

FIG. 3 is an illustration of a block diagram of a task management system for gathering distributed knowledge in accordance with an illustrative embodiment.

FIG. 4 is an illustration of a user interface of a task management system in accordance with an illustrative embodiment.

FIG. 5 is an illustration of a task tree completion sequence in accordance with an illustrative embodiment.

FIG. 6 is an illustration of a flowchart of the basic operation of a task management system in accordance with an illustrative embodiment.

FIGS. 7A and 7B are an illustration of a flowchart of a process for managing a task in accordance with an illustrative embodiment.

FIG. 8 is an illustration of a flowchart of a process for delegation in accordance with an illustrative embodiment.

FIG. 9 is an illustration of a flowchart of a method for managing a task in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

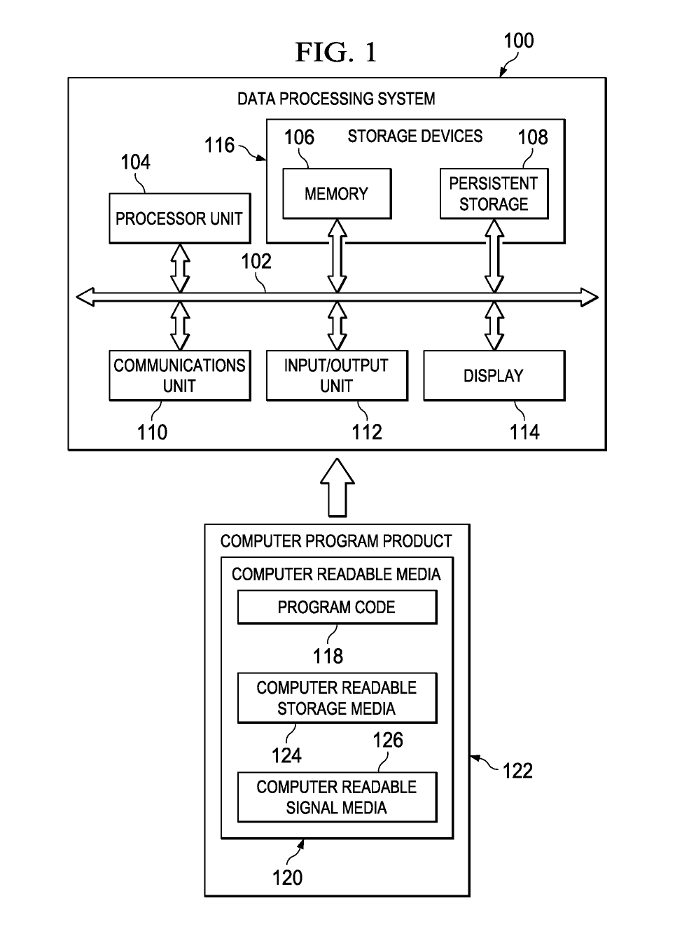

Turning now to FIG. 1, an illustration of a block diagram of a data processing system is depicted in accordance with an illustrative embodiment. In this illustrative example, data processing system 100 includes communications fabric 102, which provides communications between processor unit 104, memory 106, persistent storage 108, communications unit 110, input/output (I/O) unit 112, and display 114.

Processor unit 104 serves to process instructions for software that may be loaded into memory 106. Processor unit 104 may be a number of processors, a multi-processor core, or some other type of processor, depending on the particular implementation. A number, as used herein with reference to an item, means one or more items. Further, processor unit 104 may be implemented using a number of heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example, without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms, depending on the particular implementation.

For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications, and/or programs may be located in storage devices 116, which are in communication with processor unit 104 through communications fabric 102. In these illustrative examples, the instructions are in a functional form on persistent storage 108. These instructions may be loaded into memory 106 for processing by processor unit 104. The processes of the different embodiments may be performed by processor unit 104 using computer implemented instructions, which may be located in a memory, such as memory 106.

These instructions are referred to as program code, computer usable program code, or computer readable program code that may be read and processed by a processor in processor unit 104. The program code in the different embodiments may be embodied on different physical or tangible computer readable media, such as memory 106 or persistent storage 108.

Program code 118 is located in a functional form on computer readable media 120 that is selectively removable and may be loaded onto or transferred to data processing system 100 for processing by processor unit 104. Program code 118 and computer readable media 120 form computer program product 122 in these examples. In one example, computer readable media 120 may be computer readable storage media 124 or computer readable signal media 126. Computer readable storage media 124 may include, for example, an optical or magnetic disk that is inserted or placed into a drive or other device that is part of persistent storage 108 for transfer onto a storage device, such as a hard drive, that is part of persistent storage 108. Computer readable storage media 124 also may take the form of a persistent storage, such as a hard drive, a thumb drive, or a flash memory, that is connected to data processing system 100. In some instances, computer readable storage media 124 may not be removable from data processing system 100. In these illustrative examples, computer readable storage media 124 is a non-transitory computer readable storage medium.

Alternatively, program code 118 may be transferred to data processing system 100 using computer readable signal media 126. Computer readable signal media 126 may be, for example, a propagated data signal containing program code 118. For example, computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 118 may be downloaded over a network to persistent storage 108 from another device or data processing system through computer readable signal media 126 for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

In these illustrative examples, program code 118 may be program code for managing communications sent to customers. Program code 118 may include instructions which, when executed by processor unit 104, manage the communications. For example, program code 118 may include functions for calculating a probability of success of sending the communications. In other examples, results from sending communications to customers may be stored in memory 106 and/or persistent storage 108. Program code 118 may include instructions for analyzing the results. Based on the analysis, data processing system 100 may provide recommendations for managing the communications.

The different components illustrated for data processing system 100 are not meant to provide architectural limitations to the manner in which different embodiments may be implemented. The different illustrative embodiments may be implemented in a data processing system including components in addition to, or in place of, those illustrated for data processing system 100. Other components shown in FIG. 1 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 104 may take the form of a hardware unit that has circuits that are manufactured or configured for a particular use. This type of hardware may perform operations without needing program code to be loaded into a memory from a storage device to be configured to perform the operations.

For example, when processor unit 104 takes the form of a hardware unit, processor unit 104 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 118 may be omitted, because the processes for the different embodiments are implemented in a hardware unit.

In still another illustrative example, processor unit 104 may be implemented using a combination of processors found in computers and hardware units. Processor unit 104 may have a number of hardware units and a number of processors that are configured to run program code 118. With this depicted example, some of the processes may be implemented in the number of hardware units, while other processes may be implemented in the number of processors.

As another example, a storage device in data processing system 100 is any hardware apparatus that may store data. Memory 106, persistent storage 108, and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106, or a cache, such as found in an interface and memory controller hub that may be present in communications fabric 102.

As another example, a storage device in data processing system 100 is any hardware apparatus that may store data. Memory 106, persistent storage 108, and computer readable media 120 are examples of storage devices in a tangible form.

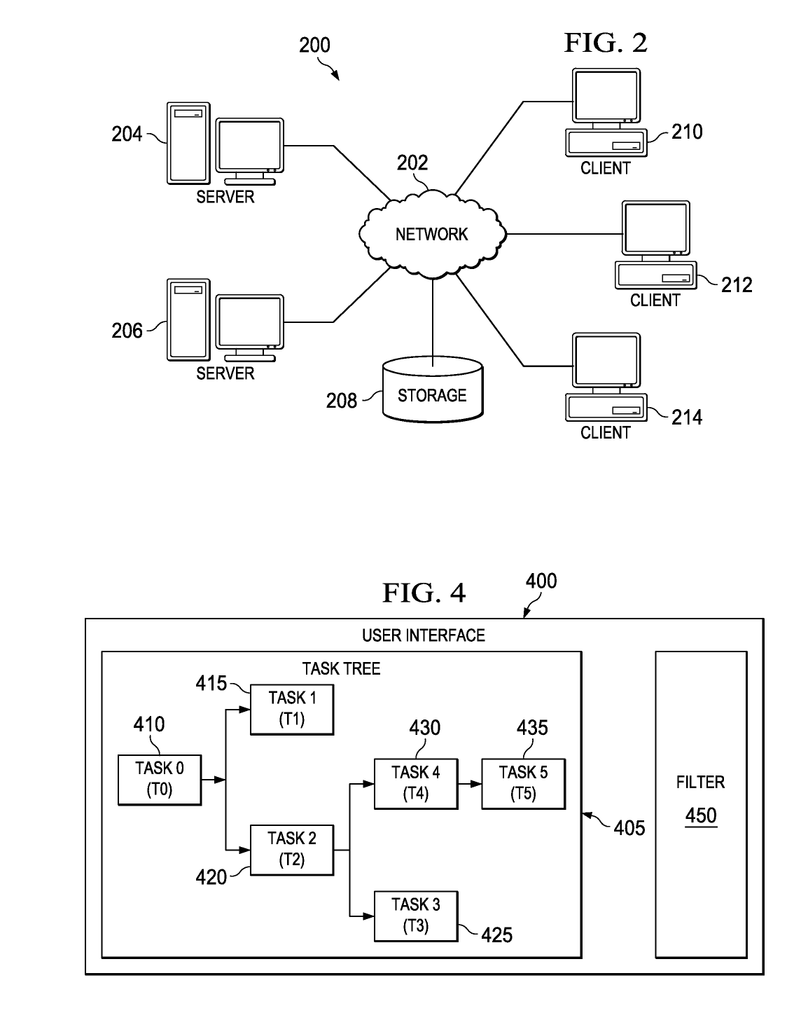

With reference now to FIG. 2, an illustrative diagram of a data processing environment is provided in which illustrative embodiments may be implemented. It should be appreciated that FIG. 2 is only provided as an illustration of one implementation and is not intended to imply any limitation with regard to the environments in which different embodiments may be implemented. Many modifications to the depicted environments may be made.

FIG. 2 depicts a pictorial representation of a network of data processing systems in which illustrative embodiments may be implemented. Network data processing system 200 is a network of computers in which the illustrative embodiments may be implemented. Network data processing system 200 contains network 202, which is the medium used to provide communications links between various devices and computers connected together within network data processing system 200. Network 202 may include connections, such as wire, wireless communication links, or fiber optic cables.

In the depicted example, server computer 204 and server computer 206 connect to network 202 along with storage unit 208. In addition, client computers 210, 212, and 214 connect to network 202. Client computers 210, 212, and 214 may be, for example, personal computers or network computers. In the depicted example, server computer 204 provides information, such as boot files, operating system images, and applications to client computers 210, 212, and 214. Client computers 210, 212, and 214 are clients to server computer 204 in this example. Network data processing system 200 may include additional server computers, client computers, and other devices not shown.

Program code located in network data processing system 200 may be stored on a computer recordable storage medium and downloaded to a data processing system or other device for use. For example, program code may be stored on a computer recordable storage medium on server computer 204 and downloaded to client computer 210 over network 202 for use on client computer 210.

In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 200 also may be implemented as a number of different types of networks, such as, for example, an intranet, a local area network (LAN), or a wide area network (WAN). FIG. 2 is intended as an example, and not as an architectural limitation for the different illustrative embodiments.

The illustrative embodiments recognize and take into account a number of different considerations. “A number”, as used herein with reference to items, means one or more items. For example, “a number of considerations” is one or more considerations.

The illustrative embodiments recognize and take into account that a computer system enables a user to remotely manage tasks distributed on a network and manage users and usage of the network. In particular, networked computers utilizing social network media and techniques can be adapted to provide interactive communication in a knowledge hierarchy. That is, people with particular knowledge can be organized, grouped, and accessed based on common attributes, usage patterns, interests, and the like. The embodiments take advantage of social network techniques to target and access network user expected to possess distributed knowledge.

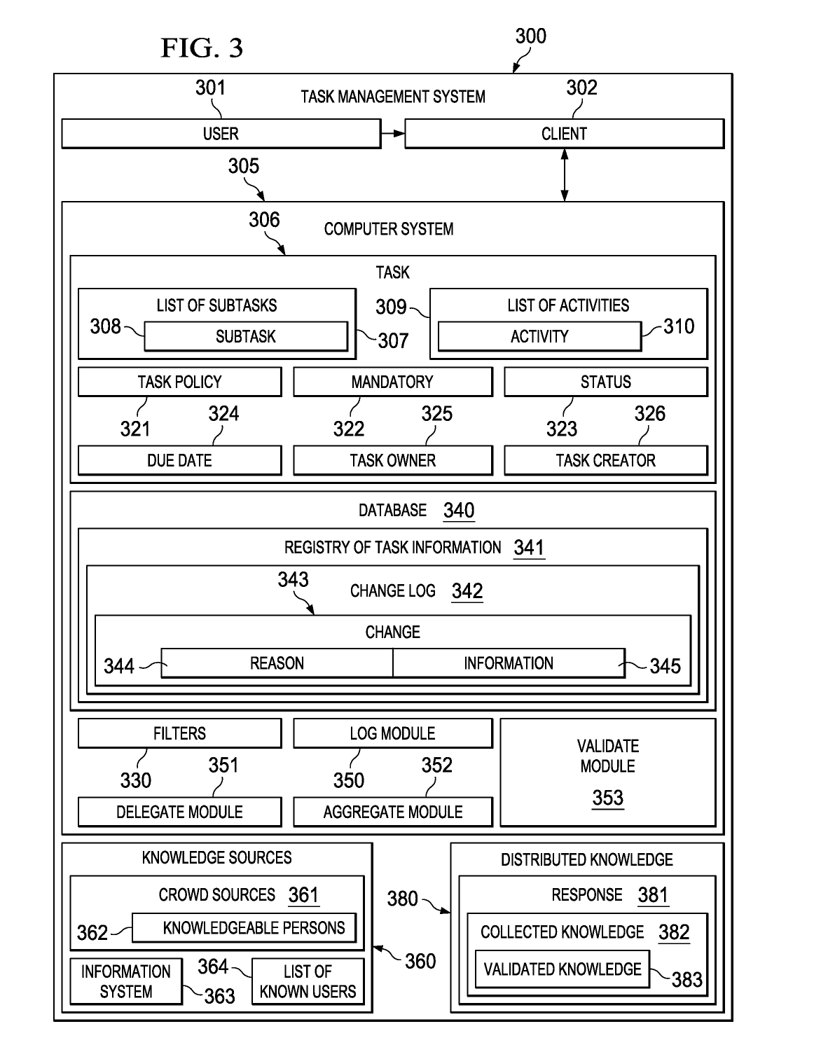

With reference now to FIG. 3, an illustration of a block diagram of a task management system for gathering distributed knowledge is depicted in accordance with an illustrative embodiment. In this illustrative example, task management system 300 is a system in which illustrative embodiments may be implemented.

“Distributed knowledge”, as used herein, means knowledge that resides outside an asset, which may be contained in a variety of documents or other knowledge storage medium, located in a number of de-centralized locations. Distributed knowledge may, for example, relate to execution or use of the asset, how people may use the asset, ad-hoc know how, best practices, or runtime requirements. Distributed knowledge may also be considered hard to discover knowledge, because it rarely can be easily discovered and may reside in many locations, both known and unknown, by one seeking the distributed knowledge.

Task management system 300 may include users such as user 301 using client computers such as client 302 to access computer system 305. Computer system 305 operates according to a programmed computer environment to transmit and receive tasks, such as task 306. Task 306 comprises at least one piece of work assigned to a user, such as user 301, to perform. Task 306 includes list of subtasks 307. List of subtasks 307 may be an empty list or include one or more subtasks, such as subtask 308. Subtask 308 may comprise a list of activities, such as list of activities 309. List of activities 309 may include one or more activities such as activity 310. Each activity 310 of the list of activities 309 of task 306 may also be included within one or more subtasks such as subtask 308 of list of subtasks 307.

“Activity”, as used herein means a specific deed or act requiring addressing by a receiver, such as, for example, user 301. To address an activity, user 301 receiving activity 310 must respond by undertaking the specific act or deed specified in activity 310.

In these illustrative examples, task 306 may include a policy such as task policy 321. Task policy 321 may comprise a requirement used to determine when task 306 is complete. For example, task policy 321 may require a particular confidence level to be achieved in the activities of task 306 before task 306 is determined by task management system 300 to be complete. The confidence level can also be considered a satisfaction level or acceptance level indicating a relative success or accuracy of task completion. Each activity 310 of task 306 can be associated with a task policy. Further, in these illustrative examples, task policy 321 may include an identification of one or more activities, as required or not required, and also include a confidence level that must be met for each identified activity before considered complete. Task policy 321 can also specify if task 306 or subtask 308 are mandatory or optional—thereby inherently embedding rules for the task completion.

Task 306 can also be identified as mandatory or not mandatory using a requirement indicator in task 306 such as mandatory 322. In other illustrative examples, one or more subtasks such as subtask 308 and one or more activities such as activity 310 may also include a requirement indicator, such as mandatory 322. Before status 323 of task 306 can change to “complete”, each activity 310 identified as mandatory 322 of task 306 must be performed. Task 306 also is designated with due date 324. Status 323 tracks processing operations as task 306 and subtask 308 are addressed by task owner 325. Task creator 326 creates task 306 and sends task 306 to task owner 325. Task owner 325 becomes designated as task owner 325 when user 301 receives task 306 or subtask 308 and accepts responsibility for task 306 or subtask 308.

Filters 330 on computer system 305 can control a view or computer system 305 access by task owner 325 or other user 301. Filter 330 can be associated with task 306, subtask 308, or activity 310. For example, when receiving task 306, filter 330 associated with each component activity 310 can control activity 310 task owner 325 can accept or perform. Filters 330 can control which user 301 receives task 306 and/or subtask 308 and/or access activity 310, view status 324, access database 340, or otherwise view knowledge relating to task 306 or subtask 308 available on computer system 305.

Database 340 stores relevant information for task management system 300 and includes registry of task information 341. Registry of task information 341 comprises change log 342 updated by task management system 300 as computer system 305 processes task 306 or subtask 308. Change log 342 includes change 343 logged into database 340 which comprises reason 344 for change 343 and information 345 that describes change 343. Registry of task information 341 stores and tracks status 323 for each activity 310, as well as, the associated list of activities 309, subtask 308, list of subtasks 307, and task 306. Change log 342 tracks change 343 as task owner 325 performs action on activity 310, list of activities 309, subtask 308, list of subtask 307, or task 306. As task owner 325 causes change 343, reason 344 and information 345, i.e., the changes made, are tracked and logged.

Computer system 305 operates software modules to process task 306 or subtask 308. Log module 350 operates to update database 340 with any change 343 caused by modified status 323. Delegate module 351 operates to segment task 306 and generate subtask 308 to send to another user 301. Delegate module 351 also operates to forward task 306 or subtask 308 to another user 301. Basically, task owner 325 can select to delegate task 306 or subtask 308 by either forwarding or segmenting and assigning task 306 or subtask 308 and associated lists of subtasks 307, list of activities 309 or activity 310. Aggregate module 352 operates to collect, tabulate, collate, combine, and process task 306 and subtask 308 inputs of performed activity 310. Validate module 353 operates to validate performed activity 310 and enable change 343 to identify task 306 or subtask 308 as complete. The validation procedure performed by validate module 353 can use several mechanisms, such as a confidence level, which can be based on past history with the specific, identified task owner 325. Validate module 353 can also use comparative analysis on performed activity 310 to identical or similar activity 310 or aggregates thereof, i.e. task 306 and/or subtask 308 and/or list of activities 309. Validate module 353 can rely on a confidence rating assigned to task owner 325, historical data for task owner 325, or an acceptable validation scoring according to one or more defined metrics.

Task management system 300 facilitates computer system 305 access to knowledge sources 360. Knowledge sources 360 comprise crowd sources 361 and associated knowledgeable persons 362. Knowledge sources 360 can also include information system 363 and list of known users 364. Validate module 353 can rely on a weighting value assigned to a group of knowledgeable persons 362 or historical data associated with knowledgeable persons 362.

“Crowd source”, as used herein, means an undefined, large group of people or crowd generally formed from online communities grouped and organized by interests, demographics, usage patterns, memberships, attributes, locales, employers, affiliated education settings, and the like. “Crowd sourcing”, as used herein, means to outsource a task, traditionally performed by an employee, online as part of a distributed problem-solving and production model by broadcasting task 306, subtask 308, or activity 310 to the unknown crowd sources 361 as an open call seeking contributors to contribute response 381. “Open call”, as used herein, means to distribute task 306 or subtask 308 as an open invitation by on-line communication over a network to invite members of crowd sources 361 to contribute response 381 to distributed task 306 or subtask 308.

One use of an illustrated example of task 306 of task management system 300 collects distributed knowledge 380. This distributed knowledge 380 can reside among multiple users 301 or knowledge sources 360 accessible by computer system 305. Response 381 to task 306 or subtask 308 collects desired distributed knowledge 380. Aggregate module 352 collects, tabulates, collates, combines, and processes response 381 to generate collected knowledge 382. Validated knowledge 383 is collected knowledge 382 validated by validate module 353.

Thus, illustrative embodiments of the present invention provide a computer implemented method, computer system, and computer program product for gathering distributed knowledge 380. Task management system 300 supports using a de-constructed survey-like approach that can segment and distribute a request for knowledge, or knowledge request, to multiple parties and other knowledge sources to solicit the knowledge sought. Each party that receives the knowledge request, or a portion(s) of the survey, e.g., task 306 and subtask 308, may choose to respond and complete the questions requested or may choose to create new knowledge requests, e.g., subtask 308, each with a set of request for knowledge, e.g., list of activities 309, and redirect them to knowledgeable persons 362 that may possess better or more relevant knowledge and thus better suited to respond.

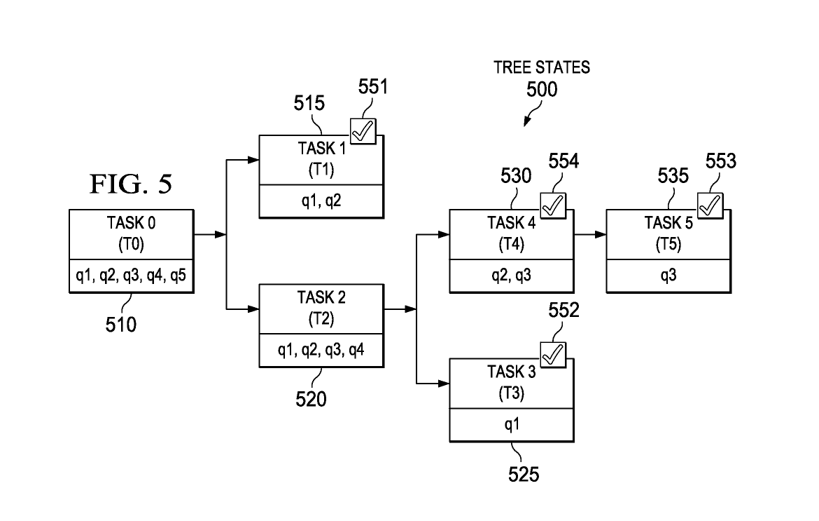

With reference now to FIG. 4, an illustration of a user interface of task management system 300 of FIG. 3 is depicted in accordance with an illustrative embodiment. User interface 400 of task tree 405 graphically depicts the formation of task tree 405 as task 306 progresses among a set of multiple users 301 of FIG. 3. Task 0 (T0) 410 generates containing at least one activity 310 of FIG. 3 associated with a request for knowledge. The subsequent tasks—Task 1 (T1) 415, Task 2 (T2) 420, Task 3 (T3) 425, Task 4 (T4) 430, and Task 5 (T5) 435—include a number of activities 310 of FIG. 3 associated with requests for knowledge, queries, questions, or the like that are subset of task 306, e.g. subtask 308 of FIG. 3 that T0 410 manages. For example, T1 415 and T2 420 created by T0 410 include a subset of queries in T0 410. The two tasks, T1 415 and T2 420, can contain the same or a differing subset of queries. Likewise, T3 425 and T4 430 created by T2 420, include a subset of queries in T2 420. T5 435, created by T4 430, will also include the same or a differing subset of queries of T4 430. It should be noted that subsequent tasks can contain the same or differing subsets of the parent task or task 306; that is child task(s) or subtask 308 of FIG. 3. For example, task T0 410 may be identical to subtask T1 415 and T2 420, or each subtask T1 415 and T2 420 can contain a different subset of queries or activity 310 of FIG. 3. Likewise, T0 410 and T5 435 can be identical if T4 430 and T2 420 contain the same queries as T0 410. However, each subtask of a task contains a subset of tasks in the task. Thus, T5 435 must contain queries also found in T4 430 though there may be fewer queries in the task. Additionally, all subtasks T1 415, T2 420, T3 425, T4 430, and T5 435 can be a forwarded task, with responsibility for the task transferred. Task tree 405 can display as view or user interface 400 accessible to user 301 as well as task owner 325 of FIG. 3 dependent on filter 450 that controls access to user interface 400.

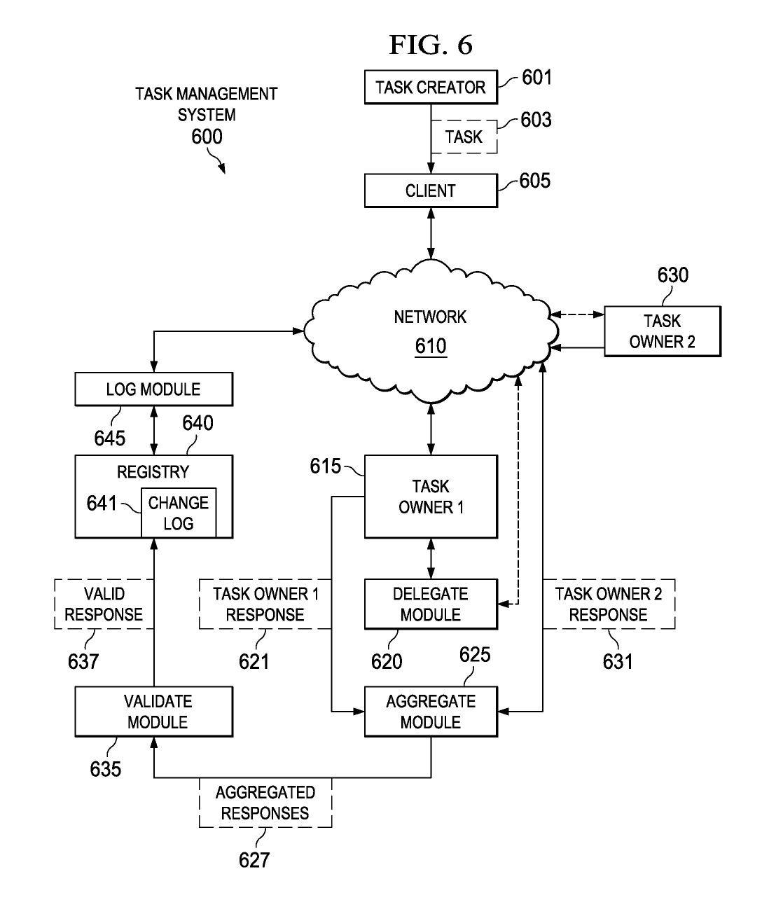

With reference now to FIG. 5, an illustration of a task tree completion sequence is depicted in accordance with an illustrative embodiment. FIG. 5 shows tree states 500 associated with tasks as determined by query responses. Assume that Task 0 (T0) 510 consists of queries q1, q2, q3, q4, and q5, Task 1 (T1) 515 consists of queries q1 and q2, Task 2 (T2) 520 consists of queries q1, q2, q3, and q4, Task 3 (T3) 525 consists of query q1, Task 4 (T4) 530 consists of queries q2 and q3, and Task 5 (T5) 535 consists of query q3; all queries are mandatory. When a received response to q1 and q2 in T1 515 validates, a complete status identifier 551 changes to signify that the system received valid responses to both q1 and q2, and the status for T1 515 indicates complete. Because T3 525 contains only q1, at the same time T1 515 completes, the system updates complete status identifier 552 for T3 525 to complete. Similarly, when a subsequent response to q3 of T5 535 validates, the system updates the complete status identifier 553 to complete, and it also updates the complete status identifier 554 to complete. Because T1 515 contained q2, and T5 535 contained q3, once T1 515 and T5 535 complete, then the status for T4 530 containing q2 and q3 changes to complete also. The completed T4 530 no longer requires any action from the task owner of T4 530, and the system can automatically remove T4 530 from queue or a list of pending tasks, such as the list of subtasks 307.

There are several reasons for adopting this asynchronous task completion sequence. First, it accelerates the completion of the survey. In essence, the asynchronous completion of a task prunes the entire subtree underneath; basically all tasks completed by transitivity as they only contain a subset of the completed questions. Second, although multiple responses may help validate or identify additional detail, this asynchronous task completion sequence helps identify both willing and strong knowledge sources. In the example of FIGS. 5, T1 515 and T4 530 task owners together are likely to be more willing than T1's task owner. This information can be applied by T0 510 to decide to target additional questions to the willing users, task owners, of T3 525 and T4 530. Finally, it allows collaboration, as two or more tasks can be created with similar set of queries, and assigned to different owners, who can separately respond to gather the knowledge. Each task owner contributes to a common effort and as the queries get answered it shares the knowledge and allows focus to those queries still requiring attention.

When a task completes, the parent task owner is notified. For example, turning to FIG. 5 again, when T1 515 completes, the system notifies task owner T0 510. This allows parent task owner T0 510 to track progress, and it allows the task owner to decide if he concurs with the answers provided, and to focus on the queries still remaining open. In other embodiments, the task automatically closes and those task owners get notified if they had already opened the task. Otherwise, the system simply deletes the task from their task list. In some embodiments, an administrator of the process can cancel tasks in progress, reopen canceled/completed tasks, or transfer tasks to other users. Administrators can also search for tasks based on the user it is assigned to, date of assignment, and state of the tasks. Administrators can further close knowledge inquiries that are no longer required, which in turn cancels all pending tasks. Administrative tasks can also handle exceptions that have not been considered.

The illustration of task management system 300 in FIG. 3, user interface 400 in FIG. 4, and tree states 500 are not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

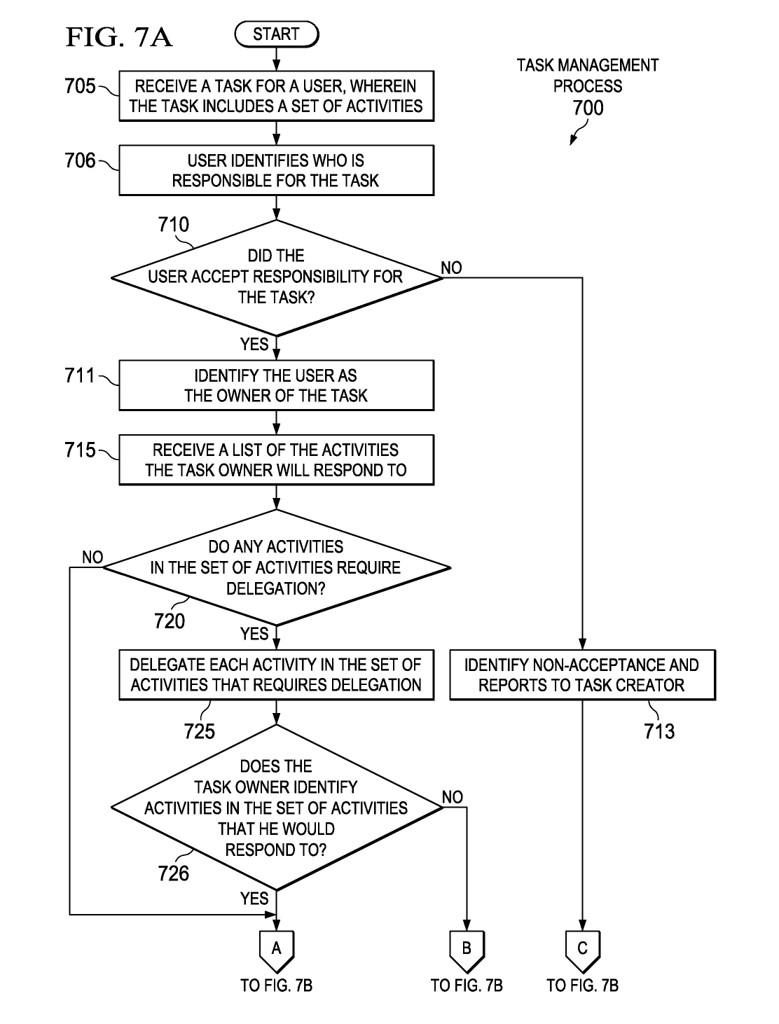

With reference now to FIG. 6, an illustration of a flowchart of the basic operation of the task management system is depicted in accordance with an illustrative embodiment. Task management system 600 is an example of one implementation of task management system 300 in FIG. 3.

Task management system 600 may be implemented using hardware, software, or a combination of the two. When implemented with hardware, the hardware may take the form of a circuit system, an integrated circuit, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices may include, for example, a programmable logic array, programmable array logic, a field programmable logic array, a field programmable gate array, and/or other suitable hardware devices. Additionally, task management system 600 may be implemented in organic components integrated with inorganic components and/or may be comprised entirely of organic components excluding a human being. When processor units are used in hardware, these processor units may be located on the same or different computers.

Task creator 601 accesses task management system 600 to create task 603 on client 605. Using client 605, task creator 601 transmits task 603 over network 610 to task owner 1 615. Task owner 1 615 becomes a task owner by accepting responsibility for completing task 603. Task owner 1 615 does not necessarily have to personally complete task 603, but task owner 1 615 only accepts responsibility for getting a response to task 603. Task 603 can be personally addressed to task owner 1 615, or task 603 can be submitted as an open call to generic users of network 610, e.g., a crowd source, with task owner 1 615 becoming aware of task 603 and, having some particular expertise relevant to task 603, actively accepts task 603. If task owner 1 615 so chooses, task owner 1 615 can optionally use delegate module 620 to either transfer responsibility or delegate actual completion of task 603.

If task owner 1 615 completes task 603, task owner 1 615 sends task owner 1 response 621 to aggregate module 625. However, if task owner 1 615 chooses to delegate task 603, either by forwarding or segmenting and inviting, delegate module 620 transmits task 603, or subtask of task 603, over network 610 to task owner 2 630, whose acceptance of task 603 is transmitted back to delegate module 620 to task owner 1 615 and task creator 601. Just as with task owner 1 615, delegated task 603 can be personally addressed to task owner 2 630, or delegated task 603 can be submitted as an open call to generic users of network 610, with task owner 2 630 becoming aware and actively accepting. Once completing task 603, task owner 2 630 sends task owner 2 response 631 to aggregate module 625.

Aggregate module 625 aggregates task owner 1 response 621 and task owner 2 response 631. The aggregation performed by aggregate module 625 can include tabulating, combining, collating, collecting, organizing, and otherwise processing task owner 1 response 621 and task owner 2 response 631 to produce a conjoined output; aggregated responses 627. Aggregate module 625, passes aggregated responses 627 to validate module 635. Validate module 635 operates to validate aggregated responses 627. Validation processing of validate module 635 can use several mechanisms to ensure valid responses to task 603, such as a required confidence level, past history with the specific task owner 1 615 and task owner 2 630, comparative analysis performed to identical or similar responses or aggregates, defined metrics, or any acceptable validation scoring and/or processing/calculating.

Once validate module 635 validates aggregated responses 627, validate module 635 outputs a valid response 637. When valid response 637 outputs from validate module 635, validate module 635 passes data to registry 640 to update change log 641 on registry 640. Log module 645 operates to manage updates to registry 640. Valid response 637 can be processed by log module 645 communicating with client 605, task owner 1 615, and task owner 2 630 to update status and indicate completion of all mandatory portions of task 603. Log module 645 also operates, in conjunction with client 605, task owner 1 615, and task owner 2 630, to update registry 640 and change log 641 as task management system 600 processes task 603.

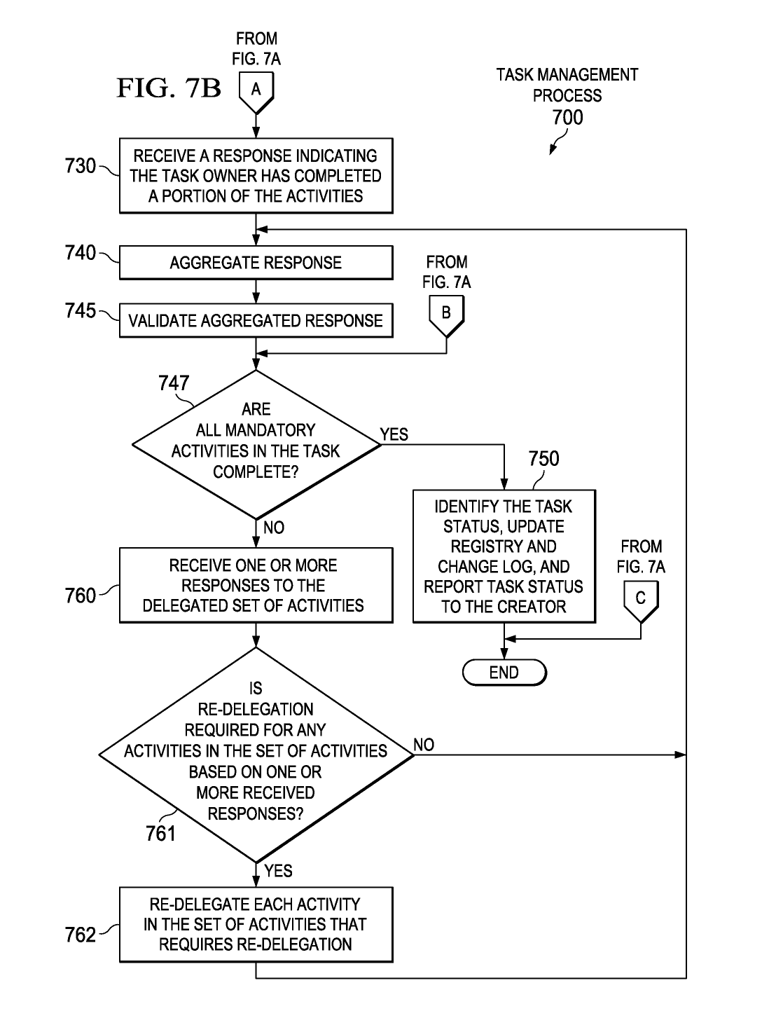

With reference now to FIGS. 7A and 7B, an illustration of a flowchart for a process for managing a task is depicted in accordance with an illustrative embodiment. Task management process 700 is an example of one implementation of task management system 300 in FIG. 3.

Task management process 700 may be implemented using hardware, software, or a combination of the two. When implemented with hardware, the hardware may take the form of a circuit system, an integrated circuit, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices may include, for example, a programmable logic array, programmable array logic, a field programmable logic array, a field programmable gate array, and/or other suitable hardware devices. Additionally, task management process 700 may be implemented in organic components integrated with inorganic components and/or may be comprised entirely of organic components excluding a human being. When processor units are used in hardware, these processor units may be located on the same or different computers.

Task management process 700 begins when it receives a task for a user, wherein the task includes a set of activities (step 705). A user identifies who is responsible for the task (step 706). A user either accepts responsibility for completing the task at this step or rejects the task. The process determines whether or not the user accepts responsibility for the task (step 710). If the user accepts responsibility, at step 711 the process identifies the user as the owner of the task. If the user rejects responsibility, or fails to accept, in step 713 the process identifies non-acceptance and reports the rejection to task creator, which ends the process. In step 715, the process receives a list of activities the task owner will respond to, and in step 720 the process determines if any activities in the set of activities require delegation. For example, a requirement for delegation may be based on a policy for completing the task within a predetermined amount of time such as specified by due date 324 of FIG. 3. If there are activities that require delegation, in step 725, the task owner acts to delegate each activity in the set of activities that requires delegation. For example, delegating a task may include arranging one or more activities into a set of subtasks, each subtask comprising one or more activities the activities of which are then further assigned to one or more knowledge sources from knowledge sources 360 of FIG. 3. The process then determines if the task owner identified activities in the set of activities that he would respond to (step 726). If in step 720, there are no activities requiring delegation, or in step 726, there are activities the task owner responds to, the process receives a response indicating the task owner has completed a portion of the activities (step 730). The task owner either has chosen to complete all the activities or to delegate only a portion of the activities. The response is then aggregated in step 740 to create an aggregated response. The process validates the aggregated response to determine if the task completes (step 745). Referring to both step 726 and 745, the process will then determine in step 747 whether all mandatory activities in the task are complete. If all mandatory activities are logged complete at this step, the process proceeds to identify the task status, updating a registry and change log, and reports task status to the creator, ending the process (step 750). The report can include updating the registry as well as a task response in a memory.

If a mandatory task stands at incomplete at step 747, the process proceeds to step 760 where the process receives one or more responses to the delegated set of activities. From there, the process proceeds to determine if re-delegation is required for any activities in the set of activities based on one or more received responses (step 761). If re-delegation is not required, the process returns to step 740. If re-delegation is required, in step 762, the process acts to re-delegate each activity in the set of activities that requires re-delegation and then returns to step 740.

At each step in the process where a task status changes, the change can be logged in a task registry. The change in status can likewise be transmitted to the task creator and/or task owner, e.g., all responses valid.

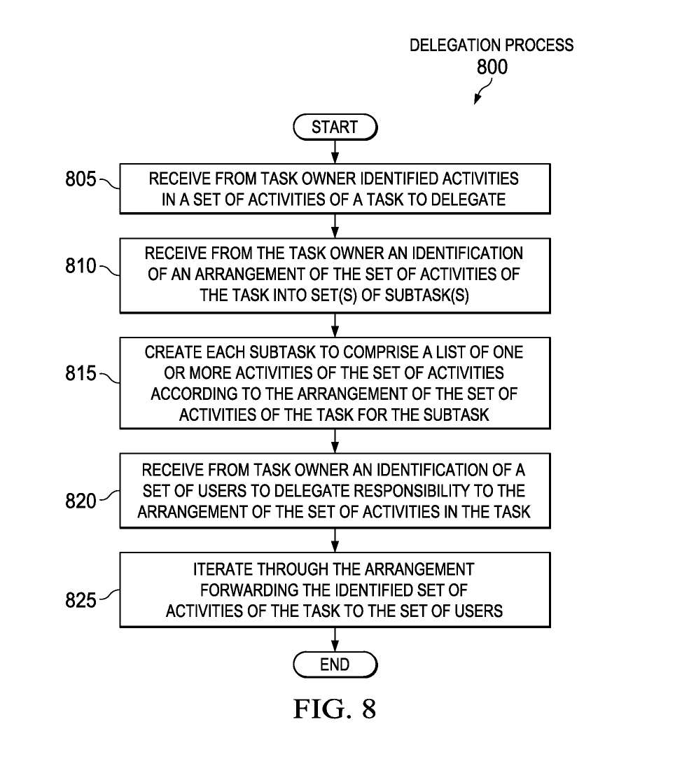

With reference now to FIG. 8, an illustration of a flowchart of a process for delegation is depicted in accordance with an illustrative embodiment. Delegation process 800 is an illustrative example of implementation of delegate module 351 in the task management system 300 in FIG. 3.

The process initiates at step 805 with receipt from a task owner identified activities in a set of activities of a task to delegate. Typically, the task owner identifies a task that requires either forwarding, transferring responsibility for completing the task to another user, or segmenting the task, creating a subtask and inviting another user for contributing to completion but retaining responsibility for completing the subtask. The process receives from the task owner an identification of an arrangement of the set of activities of the task into set(s) of subtask(s). In this step, the process receives from the task owner an identification of an arrangement of the set of activities of the task into set(s) of subtask(s) (step 810). Delegation process 800 creates each subtask to comprise a list of one or more activities of the set of activities according to the arrangement of the set of activities of the task for the subtask (step 815). The process segments a task identified for segmenting into one or more subtask as selectively identified by the task owner. The system receives from the task owner an identification of a set of users to delegate responsibility to the arrangement of the set of activities in the task (step 820). In this step, the task owner selects users to transfer responsibility for activities of the task. Then the process iterates through the arrangement forwarding the identified set of activities to the set of users (step 825). The task owner also can submit the identified set of activities as an open call to a knowledge source without designating specific users. The system also logs the task and subtask(s) and any change in status.

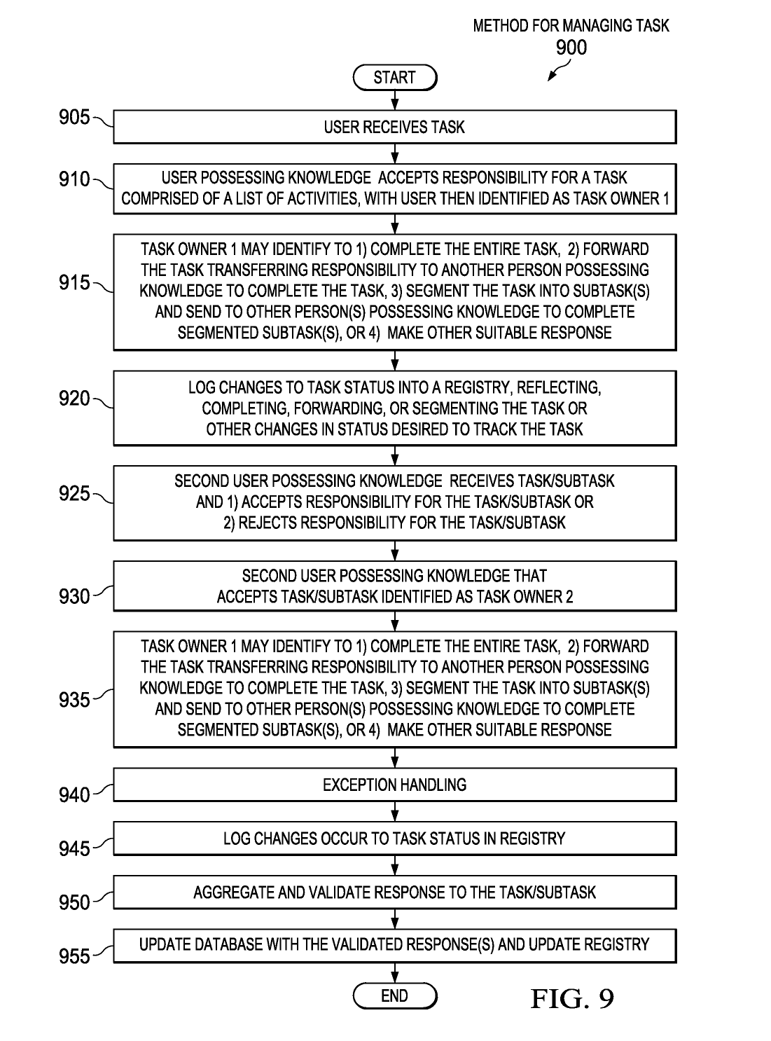

With reference now to FIG. 9, an illustration of a flowchart of a method for managing task 900 is depicted in accordance with an illustrative embodiment. The method for managing task 900 is an illustrative example of task management system 300 in FIG. 3.

The method for managing task 900 may be implemented using hardware, software, or a combination of the two. When implemented with hardware, the hardware may take the form of a circuit system, an integrated circuit, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices may include, for example, a programmable logic array, programmable array logic, a field programmable logic array, a field programmable gate array, and/or other suitable hardware devices. Additionally, method for managing task 900 may be implemented in organic components integrated with inorganic components and/or may be comprised entirely of organic components excluding a human being. When processor units are used in hardware, these processor units may be located on the same or different computers.

The method starts when a user receives a task (step 905). At least one user possessing knowledge accepts responsibility for a task comprised of a list of activities; the user thereafter identified as task owner 1 (step 910). Some or all the activities can be designated mandatory. The task owner then selects from among a number of choices (step 915). Task owner 1 may identify to 1) complete the entire task, 2) forward the task transferring responsibility to another person possessing knowledge to complete the task, 3) segment the task into subtask(s) and send to other person(s) possessing knowledge to complete the segmented subtask(s), or 4) make other suitable response. In this step, the segmented subtasks can be the same or differ, inviting one or multiple users to contribute to completing the task. Changes to task are logged into a registry, reflecting completing, forwarding, or segmenting the task or other changes in status desired to track the task (step 920).

A second user possessing knowledge receives the task/subtask and 1) accepts responsibility for the task/subtask or 2) rejects responsibility for the task/subtask (step 925). A second user possessing knowledge that accepts the task/subtask is identified as task owner 2 (step 930). Task owner 2 may identify to 1) complete the entire task, 2) forward the task transferring responsibility to another person possessing knowledge to complete the task, 3) segment the task into subtask(s) and send to other person(s) possessing knowledge to complete the segmented subtask(s), or 4) make other suitable response. Task owner 2 may complete those portions of the task he is able while segmenting other portions into subtasks (step 935). As mandatory activities, e.g., knowledge requests, in the subtask are completed, the task's task owner 1 can receive feedback indicating subtask complete. The system can track tasks and subtasks that are completed and automatically cancel and remove the completed tasks and subtasks from a task list, such as list of subtasks 307 of FIG. 3. For example, task management system 300 of FIG. 3 determines tasks and subtasks are complete as the mandatory portions of the tasks and subtasks complete. Since there are no constraints on the activities making up the subtasks, other than being a subset or segmented set of activities in the parent task, an activity can be in many subtasks and, as such, once responded to by any one task owner, the response will contribute to the completion of any other subtasks that also possesses that activity. Necessarily, task management system 300 of FIG. 3 can associate a subtask with its parent task and track tasks completed whenever all mandatory portions comprising a task are addressed throughout and wherever located within the generated task tree as seen in FIG. 5. For both task owner 1 and task owner 2, sending a list of activities to another user can comprise sending a request that lists the activities, sending a set of questions, or sending a link to a web page or program for performing a portion of the set of activities (steps 915 and 935).

Exception handling takes place (step 940). Task tracking permits forwarding and reassigning tasks as necessary. Tasks may not be responded to or may stand rejected. The process exception handling in step 940 can include reassigning back to the parent task owner, attempting re-delegation to forward or segment the task again, or sending reminders and escalations, manually and/or automatically. For example, reminders can be sent for tasks with a status of incomplete beyond a certain age in hours, days, or some other completion deadline. Reminder intervals can be set as a function of the age of the task or numbers of reminders sent previously and a level of escalations can be determined based on the number of reminders or escalations that have already taken place.

Log changes occur to task status in a registry (step 945). Changes to status can be accomplished and logged every time an action on a task or subtask occurs. Modules must aggregate and validate a response to the task/subtask (step 950). Before task status can update to complete, all mandatory activities of a task must be validated. In step 950, task and subtask undergo aggregation to produce an aggregated response that then undergoes validation to determine if a confidence scoring indicates an accurate response that can then be logged valid. When mandatory activities in the subtask are completed, the task owner 1 can receive feedback indicating subtask complete. The system can track tasks completed to automatically cancel or remove the completed task from a task list indicating open or closed task. Tasks need not be completed by their original task owner. For a task to be completed, it is sufficient to complete all its mandatory parts, many found in subtasks duplicated and assigned to multiple task owners. A response to any one subtask will contribute to the completion of any other task or subtasks that also possess that activity. Necessarily, whenever all mandatory subtasks of the generated task tree indicate valid responses to all mandatory parts, the task and subtask change log updates to complete status. After the response(s) are aggregated and validated, the process updates a database with the validated response(s) and updates a registry, such as registry of task information 341 of FIG. 3 (step 955). If all mandatory parts of a task are logged as complete, the process ends for that task.

Referring back to FIG. 3, in these illustrative examples, the task management systems disclosed herein can be used to discover distributed knowledge 380. When seeking distributed knowledge 380, it may seem natural to structure the process as a survey to attempt to address the areas of interest, but it requires a different approach to complete it. Ideally, a request seeking distributed knowledge 380, such as task 306, needs to be deconstructed into subparts, such as subtask 308, so that each party may contribute their knowledge and provide input to whatever portion of distributed knowledge 380 they possess. A deconstructed inquiry model segmenting a knowledge request into subtask(s) 308 accomplishes this goal.

There are two main data artifacts considered for defining a lifecycle of an exemplary knowledge request. One, the knowledge request, i.e., knowledge to capture, request for information, question, and the like, and two, the task associated with a knowledge request. There exists a 0 to n relationship between the two. For a given knowledge request, there can be 0 or more tasks open addressing the knowledge gathering.

A knowledge request or inquiry presents a natural representation of the knowledge capture process. It allows for quick design and to structure the data elements being gathered. It allows for responses other than specified, as response 381 received may not be part of the original choices. The inquiry can include an optional comment field that allows for a “write-in” response to those requests for knowledge that require disambiguation.

These requests for knowledge, e.g., queries, inquiries, questions, and the like, seek knowledge, or information, about a subject, object, topic, or an asset, such as hardware equipment or system configuration, for example. Also, the knowledge request generally seeks a response from multiple knowledge sources 360; not just a sole contributor. A de-constructed inquiry model can collect distributed knowledge 380 in this manner.

A fraction of a knowledge request is a knowledge request, that is, a knowledge request can de-construct into a number of separate task, with each resulting individual subtask 308 treated as a knowledge request, or task 306, in its own right. This creates a natural recursion to break down and reconstruct subtask(s) 308 of a knowledge request as response 381 from other task owners 325 to aggregate, for example in aggregate module 352, to produce collected knowledge 382, that validate, for example in validate module 353, into validated knowledge 383. From an artifact perspective, and mapped directly to the user interface perspective, a knowledge request divides into sections and for each section multiple requests for knowledge are possible. A request for knowledge can be structured as a given type, based on the type of answer expected, and presented in the user interface as described above. A request for knowledge can also contain a key, or flag, attributed to determine if it is optional or mandatory, such as identifier mandatory 322. As the name of the attribute indicates, only mandatory requests for knowledge need to be completed to close, that is validate as complete and report, a knowledge request.

In addition to the responses for each question, and as a group of people engages in responding to the knowledge request, such as crowd sources 361, there may be more than one answer for a given question. It is important to timestamp and track the person that provides each answer. This history will present the chronology of answers, with the latest response being the current one. More importantly the history trail creates a small community around each question, subsection, or the overall knowledge request. At the end of the knowledge request, a group of people that are knowledgeable about the investigated subject has been captured, for example knowledgeable persons 362. This micro-community could be applied to either validate any data entry or perhaps gather further details on the subject in question or a related subject. The identified community can be assigned a confidence score used to both validate a response in the future and to route future requests to the community for a given subject.

The concept of a task manages completion of the knowledge request. As defined herein, a task, such as task 306, is a unit of work associated with a portion of the knowledge request. Task 306 can consist of one or many request for knowledge and can comprise the entire knowledge request or a portion of the knowledge request as encompassed in a list of activities, such as list of activities 309, or an activity, such as activity 310. When a knowledge request is launched, a top task is created for the whole knowledge request. The user accepting this task can elect one of several choices to manage the task:
1) Complete the task by simply answering all mandatory portions of the task to the best of his ability.
2) Forward the task to a more knowledgeable party. By forwarding the task, the responsibility of the knowledge request transfers to someone else.
3) Invite others by segmenting the task and invite other parties to contribute to the corresponding sections. Each invitation generated creates a new task, but the current parent task remains open until all the mandatory requests associated with the each invitation generated are addressed.

The process continues in a recursive fashion, once a user accepts a task he has the same set of choices:
1) Complete the task by simply answering all mandatory queries to the best of his ability.
2) Forward the task to a more knowledgeable party. By forwarding the task, the responsibility of the knowledge request transfers to someone else.
3) Invite others by segmenting the knowledge request and invite other parties to contribute to the corresponding sections. Each invitation generated creates a new task, but the current parent task remains open until all the mandatory requests associated with the each invitation generated are addressed.

Segmenting can include creating new subset tasks, such as subtasks 308. The subset tasks can include portions of the knowledge request grouped into subdivided and related subject matter.

In essence a task tree is created comprising sets of tasks and related subtasks.

In the illustrative embodiment presented here, two basic modes exist for accepting a tasks; assignment or selection. Assignment occurs when the system or another person pre-assigns the task. Selection occurs when a person chooses a task he can manage and proceeds to complete, either by answering all the knowledge inquiries of the task or segmenting the task as described above referring to FIGS. 4 through 9. In an assignment, the notion of a network (business or social) is leveraged to identify potential users that can assist in completing the task. In a selection, the task is available as an open call ready to be crowd sourced, that is anyone willing or meeting a criteria may accept the task and proceed to handle it. Whoever accepts a task, whether by assignment or selection, is designated the task owner. If a user rejects a task, such as in the case of assigning the task incorrectly, the task returns to the previous owner. If the task was just created, it is assigned to a parent task owner.

Subtask owners can complete task. That is, tasks, such as task 306, need not be completed by their original task owner, such as task owner 325. For a task to be completed, it is sufficient to complete all its mandatory queries. Since there are no constraints on the queries that form the tasks, other than being a subset of the parent task, a query may find its way into other subsequent tasks and, as such, once completed in one task, it will contribute to the completion of any other tasks that also possesses that query.

To avoid leaf nodes in the task tree that would otherwise end in a dead end, that is un-responded to but open, the system permits forwarding and reassigning tasks as necessary. The task may have been transmitted by accident or to an incorrect address. Either the task stands rejected and reassigned to the parent task owner, T0 410 for example, or someone, such as the user rejecting the task, can forward the request to a more knowledgeable party.

When dealing with unresponsive users, but possibly knowledgeable users, such as knowledgeable persons 362, it is necessary to send reminders and escalations, manually and/or automatically, for example, reminders can be sent for tasks beyond a certain age, such as specified hours, days, etc. Reminder intervals can be set as a function of the age of the task, and a level of escalations can be determined based on the number of escalations that have taken place.

Task management system 300 can create a history recording responses provided by users for each task. This records who, when, and what knowledge was provided for each task. The history information can also include details about the user and a timestamp can be viewed at the task level and also at each query level. This information permits analysis to understand the relationships amongst those that forward or create sub tasks and to whom they contact to facilitate their knowledge capture. This information can also point to other potential contributors.

Advantages of the exemplary embodiments presented include a deconstructed approach to manage a task that permits completing or selectively delegating the task and creating subtasks to send to others. A task tree of task and subtasks can result, with each user on the tree able to contribute to task completion and/or delegate. A broad spectrum of contributors can be accessed and contribute as appropriate, with task owners able to monitor and track task completion.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing a task, the method comprising:
retrieving, by a computer system, the task including an identification of a task creator and an identification of a set of activities of the task;
identifying, by the computer system, a user who is likely to perform a portion of the set of activities, wherein the portion includes one or more activities of the set of activities;
delegating selectively, by the computer system, at least the portion of the set of activities to an identified user;
sending, by the computer system, the portion of the set of activities to the identified user;
receiving, by the computer system, a set of responses related to the portion of the set of activities;
determining, by the computer system, whether the task is complete based on a policy for establishing that the set of responses meet a configured confidence level; and
reporting, by the computer system, the set of responses to the task creator responsible for superset of responses.

2. The method of claim 1, wherein sending, by the computer system, the portion of the set of activities sent to the identified user additionally comprises:
creating a subtask of the task comprising the portion of the set of activities likely to be performed by the identified user;
sending the subtask to the identified user to perform the portion of the set of activities; and
sending the set of activities comprises sending one or more of a request that lists the activities, sending a set of questions, and sending a link to a web page or program for performing the portion of the set of activities.

3. The method of claim 1, wherein determining whether the task is complete, by the computer system, the set of responses additionally comprises:
processing one or more portions of responses aggregated into a set of collected responses according to a confidence level based on past history with the identified user.

4. The method of claim 1 additionally comprising storing, by the computer system, a log of the retrieving, identifying, sending, receiving, determining, reporting, and delegating steps.

5. The method of claim 1, wherein the user is identified based on a status of a prior task.

6. The method of claim 1 additionally comprising reporting, by the computer system, a failure to complete the task to the task creator responsive to an absence of a determining of the set of responses.

7. The method of claim 1, wherein the task additionally includes a due date for the set of activities to be completed and wherein determining whether the task is complete, by the computer system, the set of responses additionally comprises:
determining, by the computer system, if the due date has expired and if the responses meet the confidence level.

8. The method of claim 1, wherein the policy comprises meeting a confidence level to complete the task based on a metric.

9. A computer program product for managing a task, the computer program product comprising:
a computer readable storage medium;
program code, stored on the computer readable storage medium, for retrieving the task including an identification of a task creator and an identification of a set of activities of the task;
program code, stored on the computer readable storage medium, for identifying a user who is likely to perform a portion of the set of activities, wherein the portion includes one or more activities of the set of activities;
program code, stored on the computer readable storage medium, for delegating selectively at least a the portion of the set of activities to the identified user;
program code, stored on the computer readable storage medium, for sending the portion of the set of activities to the identified user;
program code, stored on the computer readable storage medium, for receiving a set of responses related to portion of the set of activities;
program code, stored on the computer readable storage medium, for determining whether the task is complete based on a policy for establishing that the set of responses meet a configured confidence level; and
program code, stored on the computer readable storage medium, for reporting the set of responses to the task creator responsive to determining completion of the set of responses.

10. The computer program product of claim 9, wherein sending the portion of the set of activities sent to the identified user additionally comprises:
program code, stored on the computer readable storage medium, for creating a subtask of the task comprising the portion of the set of activities likely to be performed by the identified user;
program code, stored on the computer readable storage medium, for sending the subtask to the identified user for performing the portion of the set of activities; and
program code, stored on the computer readable storage medium, for sending the set of activities comprises sending one or more of a request that lists the activities, sending a set of questions, and sending a link to a web page or program for performing the portion of the set of activities.

11. The computer program product of claim 9, wherein determining, by program code, stored on the computer readable storage medium, for the set of responses additionally comprises:
processing one or more portions of responses aggregated into a set of complete responses according to a confidence level based on past history with the identified user.

12. The computer program product of claim 9 additionally comprising program code, stored on the computer readable storage medium, for storing a log of the retrieving, identifying, sending, receiving, determining, and reporting steps.

13. The computer program product of claim 9, wherein program code, stored on the computer readable storage medium, identifies the user based on a status of a prior task.

14. The computer program product of claim 9 additionally comprising program code, stored on the computer readable storage medium, for reporting failure to complete the task to the task creator responsive to an absence of the determining of the set of responses.

15. The computer program product of claim 9, wherein program code, stored on the computer readable storage medium, for the task additionally includes a due date for the set of activities to be completed and a confidence level of the responses to the set of activities and wherein determining of the set of responses additionally comprises:
program code, stored on the computer readable storage medium, for determining if the due date has expired and if the responses meet the confidence level.

16. The computer program product of claim 9, wherein program code, stored on the computer readable storage medium, for the set of activities of the task include a request to retrieve knowledge about an asset or a business object.

17. A data processing system for managing tasks, the system comprising:
a bus system;
a storage device connected to the bus system, wherein the storage device includes program code;
a processor unit configured to execute the program code to retrieve a task including an identification of a task creator and an identification of a set of activities of the task; identify a user who is likely to perform a portion of the set of activities, wherein the portion includes one or more activities of the set of activities; delegate selectively at least the portion of the set of activities to identified user; send the portion of the set of activities to the identified user; receive a set of responses related to the portion of the set of activities; determine whether the task is complete based on a policy for establishing that the set of responses meet a configured confidence level; and report the set of responses to the task creator responsive to determining completion of the set of responses.

18. The data processing system of claim 17, wherein in executing the program code to send the portion of the set of activities sent to the identified user, the processor unit is further configured to execute the program to create a subtask of the task comprising the portion of the set of activities likely to be performed by the identified user; send the subtask to the identified user for performing the portion of the set of activities; and send the set of activities comprising sending one or more of a request that lists the activities, sending a set of questions, and sending a link to a web page or program for performing the portion of the set of activities.

19. The data processing system of claim 17, wherein in executing the program code to validate the set of responses, the processor unit is further configured to execute the program to process one or more portions of responses aggregated into a set of collected responses according to a confidence level based on past history with the identified user.

20. The data processing system of claim 17, wherein in executing the program code to store a log, the processor unit is further configured to log the retrieve, identify, send, receive, determine, report, and delegate steps.

21. The data processing system of claim 17, wherein in executing the program code to identify the user, the processor unit is further configured to identify the user based on a status of a prior task.

22. The data processing system of claim 17, wherein in executing the program code to report a failure to complete the task, the processor unit is further configured to report the failure to complete the task to the task creator responsive to an absence of the determination of the set of responses.

23. The data processing system of claim 17, wherein in executing the program code, the task additionally includes a due date for the set of activities to be completed and a confidence level of the responses to the set of activities and wherein the processor unit is further configured to determine the set of responses, which additionally comprises determining if the due date has expired and if the responses meet the confidence level.

24. A method for managing tasks, the method comprising:
receiving, by a computer system, an identification of a set of activities for a task, a time for the task to complete, and a confidence level for each activity to meet;
logging, by the computer system, a task owner acceptance of responsibility for a received task, the task owner selectively performing an action comprising accept, then subsequent thereto, complete or delegate the task, wherein delegate comprises
forward the task to a second user and transferring responsibility, or
segment the task to create at least one subtask and invite at least one second user to contribute to complete the task;
aggregating, by the computer system, a completed task and subtask;
wherein the second user, by the computer system, receives the subtask and selectively performs the actions of accept, then complete or delegate for the subtask.

25. The method of claim 24, wherein the task and subtask comprises a request for knowledge.
